(19) United States
(12) Patent Application Publication
(10) Pub. No.: US 2006/0089104 A1
(43) Pub. Date: Apr. 27, 2006

(54) Method for improving an HS-DSCH transport format allocation

(75) Inventors: Jorma Kaikkonen, Oulu (FI); Sari Nielsen, Espoo (FI); Troels Kolding, Klarup (DK); Klaus Pedersen, Aalborg (DK)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/976,019

(22) Filed: Oct. 27, 2004

(51) Int. Cl. H04B 17/00; H04Q 7/20; H04B 7/00

(52) U.S. Cl. 455/67.13; 455/452.2; 455/513

(57) ABSTRACT

This invention describes a method for a new methodology for improving a high speed downlink shared channel (HS-DSCH) transport format allocation in communication systems (e.g., mobile phone networks) using, e.g., a network element such as a node B. As CQI (channel quality indicator) reports made by a user terminal) are time stamped in a sense that they correspond to a given reference period, the Node B is able to determine what time instant in the past the given CQI report corresponds to. As the Node B scheduler knows a history of HS-DSCH (high speed downlink shared channel) transmission, it is able to determine how much HS-DSCH power was transmitted during the time corresponding to the received CQI report. Based on this information, it determines the bias required to the CQI reports received at different times to improve an accuracy of the allocated HS-DSCH transport format.

### TECHNICAL FIELD

This invention generally relates to communication networks and more specifically to improving a high speed downlink shared channel (HS-DSCH) transport format allocation.

### BACKGROUND ART

In the current 3GPP specifications for HSDPA (high speed downlink packet access) functionality, the UE (user equipment) is required to report the highest channel quality indicator (CQI) value from a given table that the UE estimates that it can receive with a transport block error probability not exceeding 0.1 during a defined reference period. This reference period is defined to last three slots and it ends one slot before the CQI needs to be reported on the uplink. A Node B (or a network element) can utilize these reports when it schedules an HS-DSCH (high speed downlink shared channel) for different users.

When the UE reports the CQI, it needs to estimate the observed quality of the DL (downlink) channel. This can be done, for example, by calculating the SIR (signal-to-interference ratio) of CPICH (common pilot channel) assigned as a phase reference for the HS-DSCH. The SIR realized at the UE depends on the actual propagation conditions and in case the orthogonality is lost for some reason, also depends on their own cell transmission power. If the transmission of the HS-DSCH is not continuous (e.g., abrupt on-off scheduling caused by a bursty nature of the packet data traffic), the CQI reported when no HS-DSCH is allocated to anyone will differ from the situation when the HS-DSCH is actually allocated, i.e. transmitted.

If the used power allocation for the HS-DSCH is high and the amount of load/users in the DL is low and fragmented, the CQIs reported by the UE will be biased due to a time varying own cell interference. Besides, from the on/off effects caused by burstiness of a packet data traffic, fragmenting of a DL traffic may be also caused since a lower category HSDPA UE is not required to be able to receive a continuous HS-DSCH transmission. Lower UE classes need to be able to receive every third or second (HSDPA) sub-TTI (transmission time interval) depending on the category. Furthermore, same HARQ (hybrid automatic repeat request)-processes can be only addressed with a (re-)transmission every sixth sub-TTI.

### DISCLOSURE OF THE INVENTION

The object of the present invention is to provide a methodology for improving a high speed downlink shared channel (HS-DSCH) transport format allocation in communication systems (e.g., mobile phone networks) using, e.g., a network element such as a node B.

According to a first aspect of the invention, a method for improving a channel transport format allocation, comprises the steps of: providing to a CQI filter module a CQI signal indicative of channel quality indicator (CQI) data for a channel, optionally based on a channel signal, respectively; providing to a CQI filter module an activity signal containing a history of the channel signal; and providing by a CQI filter module a modified CQI signal in response to the CQI signal and using the activity signal, wherein the modified CQI signal is used for improving the channel transport format allocation in the channel thus optimizing scheduling of the channel signal.

According further to the first aspect of the invention, the activity signal may contain a power and time history of the signal. Further, the activity signal may be provided to the CQI filter module by an adaptation and scheduling module.

Further according to the first aspect of the invention, the channel may be a high speed downlink shared channel (HS-DSCH) and the channel signal may be an HS-DSCH signal. Still further, the channel quality indicator signal may be provided by a receiver in response to a CQI report signal indicative of the channel quality indicator (CQI) data and provided to the receiver by the user terminal. Yet still further, the receiver, the CQI filter module and an adaptation and scheduling module may be components of a network element of a wireless communication system and wherein the HS-DSCH signal may be provided to the user terminal optionally by the adaptation and scheduling module. Still yet further, the method may further comprise the step of: adjusting an allocated DS-DSCH transport format based on an intended HS-DSCH power allocation for providing the HS-DSCH signal to the user terminal using the modified CQI signal, wherein the adjusting is optionally performed by an adaptation and scheduling module. Yet still further, the method may further comprise the step of: adjusting an intended HS-DSCH power allocation for the HS-DSCH signal to be provided to the user terminal based on the modified CQI signal, wherein the adjusting is optionally performed by an adaptation and scheduling module.

According to a second aspect of the invention, a network element for improving a channel transport format allocation, comprises: a receiver, responsive to a CQI report signal indicative of channel quality indicator (CQI) data for a channel, for providing a CQI signal indicative of the channel quality indicator (CQI) data; a CQI filter module, responsive to the CQI signal and to an activity signal containing a history of a channel signal provided by the network element, for providing a modified CQI signal; and an adaptation and scheduling module, responsive to the modified CQI signal, optionally for providing the activity signal; wherein the modified CQI signal is used for the improving the channel transport format allocation in the channel thus optimizing scheduling of the channel signal.

According further to the second aspect of the invention, the network element may be a node B.

Further according to the second aspect of the invention, the activity signal may contain a power and time history of the channel signal.

Still further according to the second aspect of the invention, the channel may be a high speed downlink shared channel (HS-DSCH) and the channel signal may be an HS-DSCH signal. Further, the CQI report signal may be generated and provided by a user terminal optionally based on the HS-DSCH signal to the user terminal by the network element. Still further, the network elements may be for adjusting an allocated DS-DSCH transport format based on an intended HS-DSCH power allocation for providing the HS-DSCH signal to the user terminal using the modified CQI signal, and the adjusting may be optionally implemented by an adaptation and scheduling module. Yet further still, the network element may be for adjusting an intended HS-DSCH power allocation for the HS-DSCH signal to be provided to the user terminal based on the modified CQI signal, and the providing may be optionally implemented by an adaptation and scheduling module.

According to a third aspect of the invention, a communication system for improving a channel transport format allocation, comprises: a user terminal, responsive to or for providing a channel signal, optionally for providing a CQI report signal indicative of channel quality indicator (CQI) data for a channel; and a network element, responsive to the CQI report signal, for providing an activity signal containing a history of the channel signal to improve the channel transport format allocation in the channel, thus optimizing scheduling of the channel signal, based on the CQI report signal and on the activity signal.

According further to the third aspect of the invention, the network element may be a node B.

Further according to the third aspect of the invention, the activity signal may contain a power and time history of the channel signal.

Still further according to the third aspect of the invention, the network element is for adjusting an allocated channel transport format based on an intended channel power allocation for providing the channel signal to or from the user terminal using the modified CQI signal, and the adjusting may be optionally implemented by an adaptation and scheduling module of the network element.

According further to the third aspect of the invention, the network element may be for adjusting an intended channel power allocation for the channel signal to be provided based on the modified CQI signal, and the providing may be optionally implemented by an adaptation and scheduling module an adaptation and scheduling module of the network element.

According still further to the third aspect of the invention, the channel may be a high speed downlink shared channel (HS-DSCH), the user terminal may be responsive to the channel signal, the channel signal is an HS-DSCH signal and the user terminal provides the CQI report signal. Further, the network element may further comprise: a receiver, responsive to the CQI report signal, for providing a CQI signal indicative of the channel quality indicator (CQI) data; a CQI filter module, responsive to the CQI signal and to the HS-DSCH activity signal, for providing a modified CQI signal; and an adaptation and scheduling module, responsive to the modified CQI signal, optionally for providing the HS-DSCH activity signal.

According to a fourth aspect of the invention, a computer program product may comprise: a computer readable storage structure embodying computer program code thereon for execution by a computer processor with said computer program code characterized in that it includes instructions for performing the steps of the first aspect of the invention indicated as being performed by any component or a combination of components capable of improving said channel transport format allocation.

Currently, the uncertainty of the UE CQI (user equipment channel quality indicator) reports can be partly compensated for by monitoring received ACK/NACK messages for previous transmissions. Hence, an allocated HS-DSCH transport format is either positively or negatively “biased” to adjust an ACK/NACK ratio towards a desired target. The present invention can be used to improve the accuracy of a current “outer loop” algorithm (based on the received ACK/NACK messages). Thus, this would lead to an improved HS-DSCH link adaptation and scheduling performance. Moreover, if the UE is only allocated rarely on the HS-DSCH, the ACK/NACK reports are not readily available. Still further, the outer loop compensation method does not solve an on/off effect bias in instantaneous terms but can only make an average compensation.

As the DL transmits power, control commands sent by the UE also depend on the observed interference conditions in the DL; their accuracy in scheduling sense will suffer the same “self-interference” as the reception of the HS-DSCH. This method of the present invention can increase the benefit of the reported CQIs and thus improve the overall power control loop.

Furthermore, by increasing the usability/accuracy of the CQI report by accounting the “self-interference” in a Node B scheduler, the frequency at which the CQI reports need to be transmitted can be potentially reduced. This will naturally have a positive impact on a UL noise rise, thus increasing the UL coverage in general and also possibly enhancing the coverage of higher data rate services by reducing the needed back-off in a UE transmitter due to a larger number of codes.

### BRIEF DESCRIPTION OF THE DRAWINGS

For a better understanding of the nature and objects of the present invention, reference is made to the following detailed description taken in conjunction with the following drawings, in which:

FIG. 1 is a block diagram for improving a high speed downlink shared channel (HS-DSCH) transport format allocation, according to the present invention;

FIG. 2 is a block diagram for implementing a CQI filter module of FIG. 1, according to the present invention; and

FIG. 3 is a flow chart demonstrating a methodology for improving a high speed downlink shared channel (HS-DSCH) transport format allocation, according to the present invention.

### BEST MODE FOR CARRYING OUT THE INVENTION

The present invention provides a new methodology for improving a high speed downlink shared channel (HS-DSCH) transport format allocation in communication systems (e.g., mobile phone networks) using, e.g., a network element such as a node B.

As CQI (channel quality indicator) reports made by a UE (user equipment, or alternatively called user terminal) are time stamped in a sense that they correspond to a given reference period, the Node B is able to determine what time instant in the past the given CQI report corresponds to. As the Node B scheduler knows the history of HS-DSCH (high speed downlink shared channel) transmission, it is able to determine how much HS-DSCH power was transmitted during the time corresponding to the received CQI report. Based on this information, it determines the bias required to the CQI reports received at different times to improve an accuracy of the allocated HS-DSCH transport format. Hence, the node B is capable of estimating the impact of the generated DL (downlink) interference due to a lack of orthogonality to a UE HS-DSCH reception performance.

According to the present invention, a possible way for the Node B scheduler to evaluate the impact of own cell interference to the UE HS-DSCH reception performance is to compare the received CQI reports at different times (HS-DSCH transmission ON/OFF). Based on the observed difference, a required bias for the HS-DSCH transport format is estimated accounting for an intended HS-DSCH power allocation. Inversely, this information can be also used to adjust the intended HS-DSCH power allocation for a particular user (reducing the amount of a generated interference). This method can work particularly well at low speeds or in cases where the CQI report is transmitted at short intervals.

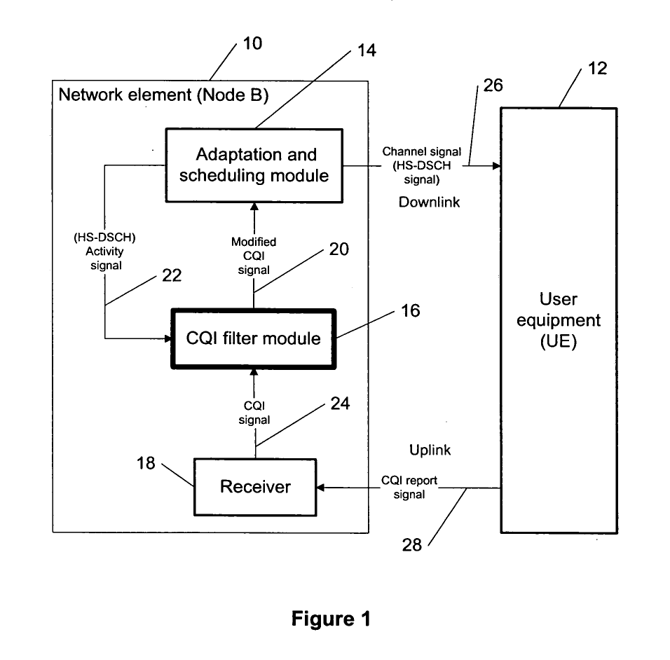

FIG. 1 shows an example among others of a block diagram for improving a high speed downlink shared channel (HS-DSCH) transport format allocation, according to the present invention.

A user terminal 12 generates a CQI report signal 28 containing channel quality indicator data regarding a downlink (DL) channel and provides the CQI report signal 28 to a receiver 18 of a network element (e.g., node B) 10. The CQI report signal 28 can be generated, for example, by calculating the SIR of a HS-DSCH signal (or a channel signal) 26 provided to the user terminal 12 as described below or by calculating the SIR (signal-to-interference ratio) of CPICH (common pilot channel) assigned as a phase reference for the HS-DSCH. The latter approach is directly applicable only if the HS-DSCH is allocated for the particular UE. To apply this method, the UE also needs to estimate the power difference between the HS-PDSCH allocated for the particular UE and the total signaled HS-DSCH power allocation. This is because there is a possibility that not all available HSDPA power, which should be used as a reference level in the CQI reporting, is allocated for the particular UE but the UE makes the CQI report based on an assumption that all available HS-DSCH power will be used for that particular UE.

In response to the signal 28, the receiver 18 generates a CQI signal 24 indicative of received channel quality indicator data and provides the CQI signal 24 to a CQI filter 16 of the network element 10. Consequently, an adaptation and scheduling module 14 provides an HS-DSCH activity signal (or an activity signal) 22 to the CQI filter 16, wherein the signal 22 contains history of the HS-DSCH signal 26 as a function of power and time transmitted during the time interval used for generating the CQI report signal 28 to the CQI filter 16.

The CQI filter 16 compares CQI reports at different times, i.e., when the HS-DSCH signal 26 “on” and “off”, using the CQI signal 24 and the HS-DSCH activity signal 22 thus generating and providing a modified CQI signal 20 to the adaptation and scheduling module 14. According to a preferred embodiment of the present invention, modification of the CQI signal 24 occurs to a great extent when the CQI report signal 28 corresponds to the “off” periods of the HS-DSCH signal 26.

If the CQI report corresponds to a time period when the HSDPA is not active (not allocated at all), or the power allocation used is smaller, the CQI report can be too optimistic depending on the loss of the orthogonality in downlink, i.e., the amount of “self interference”.

Moreover, the CQI report might not only need to be modified when report corresponds to a time period when the HSDPA is “off” or the used power allocation is lower, but also when the HSDPA power allocation of the particular network element (Node B) is changed by a network control entity or when the scheduler allocates some particular user with significantly different power allocation compared to what was used at the time period of the CQI reports used as a reference. In this case the CQI can be considered also to be too pessimistic.

In response to the modified CQI signal 20, the adaptation and scheduling module 14 (or alternatively another block of the network element 10) provides adjusting of an allocated HS-DSCH transport format based on an intended HS-DSCH power allocation for providing the HS-DSCH signal 26 to the user terminal 12. Moreover, the adaptation and scheduling module 14 (or alternatively another block of the network element 10) can facilitate adjusting of the intended HS-DSCH power allocation for the HS-DSCH signal 26 to be provided to the user terminal 12 based on said modified CQI signal 20.

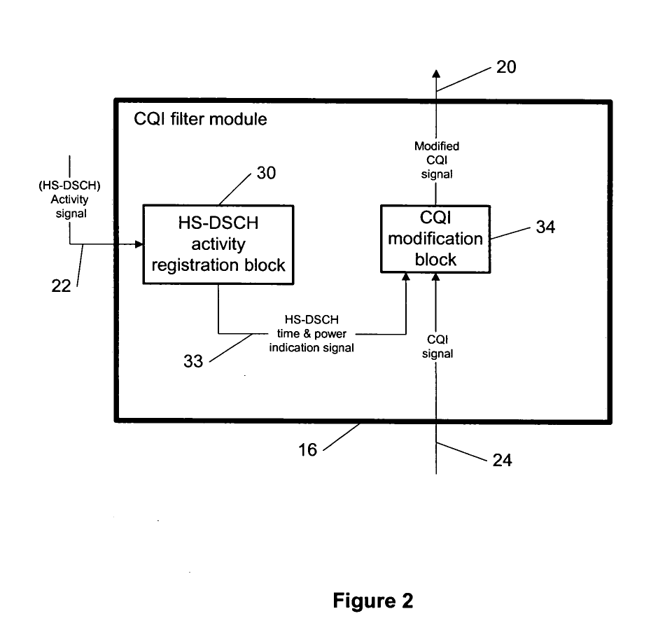

FIG. 2 shows an example among many others of a block diagram for implementing a CQI filter module 16 of FIG. 1, according to the present invention. Here, in response to the HS-DSCH activity signal 22, an HS-DSCH activity registration block 30 generates and provides an HS-DSCH time and power indication signal 33 to a CQI modification block 34. Signal 33 contains the history of the HS-DSCH signal 26 (as a function of time and power) and matches the time history of the HS-DSCH signal 26 (“on” and “off” periods of the signal 26) with the corresponding periods of the CQI report signal 28.

The CQI modification block 34 of the CQI filter 16 essentially compares CQI reports at different times, when the HS-DSCH signal 26 is “on” and “off”, using the CQI signal 24 and the HS-DSCH time and power indication signal 33 thus generating and providing a modified CQI signal 20 to the adaptation and scheduling module 14 as described above. Also, as indicated above, the accuracy of the scheduling can benefit from the information contained in the modified CQI signal 20 if the power allocation for the HS-DSCH signal 26 is significantly different from the level which was used when the CQI was reported.

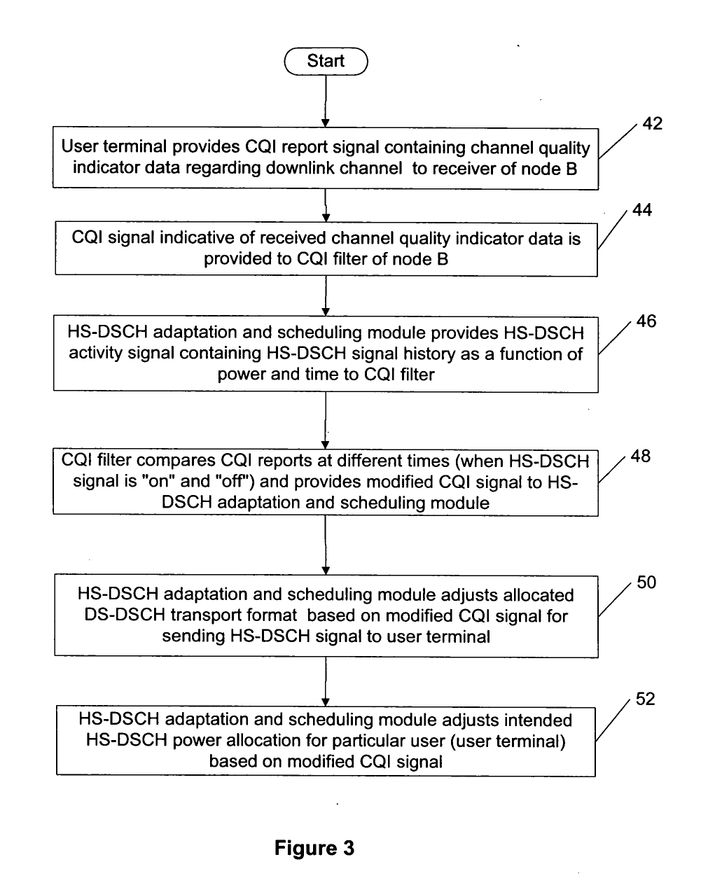

FIG. 3 is a flow chart demonstrating a methodology for improving a high speed downlink shared channel (HS-DSCH) transport format allocation, according to the present invention.

The flow chart of FIG. 3 represents only one possible scenario among many others. In a method according to the present invention, in a first step 42, the user terminal 12 generates the CQI report signal 28 containing the channel quality indicator data regarding the downlink (DL) channel and provides the CQI report signal 28 to the receiver 18 of the network element (e.g., node B) 10. In a next step 44, the receiver 18 generates the CQI signal 24 indicative of the received channel quality indicator data and provides the CQI signal 24 to the CQI filter 16 of the network element 10 (node B). In a next step 46, the adaptation and scheduling module 14 provides an HS-DSCH activity signal 22 containing HS-DSCH signal history as a function of power and time to the CQI filter 16.

In a next step 48, the CQI filter 16 compares the CQI reports at different times, i.e., when the HS-DSCH signal 26 is “on” and “off”, using the CQI signal 24 and the HS-DSCH activity signal 22 thus generating and providing a modified CQI signal 20 to the adaptation and scheduling module 14.

In a next step 50, the adaptation and scheduling module 14 adjusts the allocated DS-DSCH transport format based on an intended HS-DSCH power allocation thus providing an appropriate HS-DSCH signal 26 to the user terminal 12 based on the modified CQI signal 20. Finally, in a next step 52, the adaptation and scheduling module 14 adjusts the intended HS-DSCH power allocation for the HS-DSCH signal 26 to be provided to the user terminal 12 based on said modified CQI signal 20.

It is noted that the present invention can be applied to improving an uplink transport format allocation using similar methodology described above.

What is claimed is:

1. A method for improving a channel transport format allocation, comprising the steps of:
providing to a CQI filter module a CQI signal indicative of channel quality indicator (CQI) data for a channel, optionally based on a channel signal, respectively;
providing to a CQI filter module an activity signal containing a history of said channel signal; and
providing by a CQI filter module a modified CQI signal in response to said CQI signal and using said activity signal, wherein said modified CQI signal is used for said improving said channel transport format allocation in said channel thus optimizing scheduling of said channel signal.

2. The method of claim 1, wherein said activity signal contains a power and time history of said signal.

3. The method of claim 2, wherein said activity signal is provided to the CQI filter module by an adaptation and scheduling module.

4. The method of claim 1, wherein said channel is a high speed downlink shared channel (HS-DSCH) and said channel signal is an HS-DSCH signal.

5. The method of claim 4, wherein said channel quality indicator signal is provided by a receiver in response to a CQI report signal indicative of said channel quality indicator (CQI) data and provided to said receiver by said user terminal.

6. The method of claim 5, wherein said receiver, said CQI filter module and an adaptation and scheduling module are components of a network element of a wireless communication system and wherein said HS-DSCH signal is provided to the user terminal optionally by said adaptation and scheduling module.

7. The method of claim 4, further comprising the step of:
adjusting an allocated DS-DSCH transport format based on an intended HS-DSCH power allocation for providing said HS-DSCH signal to the user terminal using said modified CQI signal, wherein said adjusting is optionally performed by an adaptation and scheduling module.

8. The method of claim 4, further comprising the step of:
adjusting an intended HS-DSCH power allocation for said HS-DSCH signal to be provided to the user terminal based on said modified CQI signal, wherein said adjusting is optionally performed by an adaptation and scheduling module.

9. A computer program product comprising: a computer readable storage structure embodying computer program code thereon for execution by a computer processor with said computer program code characterized in that it includes instructions for performing the steps of the method of claim 1 indicated as being performed by any component or a combination of components capable of improving said channel transport format allocation.

10. A network element for improving a channel transport format allocation, comprising:
a receiver, responsive to a CQI report signal indicative of channel quality indicator (CQI) data for a channel, for providing a CQI signal indicative of said channel quality indicator (CQI) data;
a CQI filter module, responsive to said CQI signal and to an activity signal containing a history of a channel signal provided by said network element, for providing a modified CQI signal; and
an adaptation and scheduling module, responsive to said modified CQI signal, optionally for providing said activity signal.
wherein said modified CQI signal is used for said improving said channel transport format allocation in said channel thus optimizing scheduling of said channel signal.

11. The network element of claim 10, wherein said network element is a node B.

12. The network element of claim 10, wherein said activity signal contains a power and time history of said channel signal.

13. The network element of claim 10, wherein said channel is a high speed downlink shared channel (HS-DSCH) and said channel signal is an HS-DSCH signal.

14. The network element of claim 13, wherein said CQI report signal is generated and provided by a user terminal optionally based on the HS-DSCH signal to said user terminal by said network element.

15. The network element of claim 14, wherein said network element is for adjusting an allocated DS-DSCH transport format based on an intended HS-DSCH power allocation for providing said HS-DSCH signal to the user terminal using said modified CQI signal, said adjusting is optionally implemented by an adaptation and scheduling module.

16. The network element of claim 14, wherein said network element is for adjusting an intended HS-DSCH power allocation for said HS-DSCH signal to be provided to the user terminal based on said modified CQI signal, said providing is optionally implemented by an adaptation and scheduling module.

17. A communication system for improving a channel transport format allocation, comprising:
a user terminal, responsive to or for providing a channel signal, optionally for providing a CQI report signal indicative of channel quality indicator (CQI) data for a channel; and
a network element, responsive to said CQI report signal, for providing an activity signal containing a history of said channel signal to improve the channel transport format allocation in said channel, thus optimizing scheduling of said channel signal, based on said CQI report signal and on said activity signal.

18. The communication system of claim 17, wherein said network element is a node B.

19. The communication system of claim 17, wherein said activity signal contains a power and time history of said channel signal.

20. The communication system of claim 17, wherein said network element is for adjusting an allocated channel transport format based on an intended channel power allocation for providing said channel signal to or from the user terminal using said modified CQI signal, said adjusting is optionally implemented by an adaptation and scheduling module of said network element.

21. The communication system of claim 17, wherein said network element is for adjusting an intended channel power allocation for said channel signal to be provided based on said modified CQI signal, said providing is optionally implemented by an adaptation and scheduling module an adaptation and scheduling module of said network element.

22. The communication system of claim 17, wherein said channel is a high speed downlink shared channel (HS-DSCH), said user terminal is responsive to said channel signal, said channel signal is an HS-DSCH signal and said user terminal provides said CQI report signal.

23. The communication system of claim 22, wherein the network element comprises:
a receiver, responsive to said CQI report signal, for providing a CQI signal indicative of said channel quality indicator (CQI) data;
a CQI filter module, responsive to said CQI signal and to said HS-DSCH activity signal, for providing a modified CQI signal; and
an adaptation and scheduling module, responsive to said modified CQI signal, optionally for providing said HS-DSCH activity signal.
